(19) United States
(12) Patent Application Publication
(10) Pub. No.: US 2012/0280549 A1
(43) Pub. Date: Nov. 8, 2012

(54) CHAIR ADJUSTMENT MECHANISM

(75) Inventor: Jacob Goldszer, Weston, FL (US)

(73) Assignee: JGR Copa, LLC, Hollywood, FL (US)

(21) Appl. No.: 13/102,783

(22) Filed: May 6, 2011

(51) Int. Cl. A47C 1/031; G05G 1/00

(52) U.S. Cl. 297/359; 74/491

(57) ABSTRACT

An adjustment mechanism for a chair includes a housing and an adjustment element that is movable relative to the housing into a selectable one of at least two adjustment positions. Preferably, when assembled to a chair, the housing, possibly along with other elements of the chair, such as the armrest, completely encloses interlocking adjustment surfaces of the adjustment mechanism with the exception of a guide slot of the housing through which movement of the adjustment element is permitted between the at least two adjustment positions. The guide slot has a maximum width dimension sufficiently small to inhibit or prevent foreign objects from coming into contact with the interlocking adjustment surfaces of the adjustment mechanism.

### BACKGROUND OF THE INVENTION

1. Field of the Invention

The present invention relates to adjustment mechanisms for adjustable or foldable chairs, or other adjustable items.

2. Description of the Related Art

Adjustment mechanisms for adjustable or foldable chairs permit a portion of the chair to be positioned in a selected one of a number of different positions, or may simply permit the chair to be folded into a collapsed position. Such adjustment mechanisms need to be reliable in operation, provide ease of adjustment, permit relatively flat folding of the chair, and be relatively inexpensive to manufacture and easy to assemble. Prior art adjustment mechanisms that meet many or all of the desirable design characteristics described above, often expose the interlocking engagement surfaces of the mechanism, which can create a pinch hazard during folding, unfolding or adjustment of the chair.

### SUMMARY OF THE INVENTION

A need exists for adjustment mechanisms for chairs, or other objects, which meet a significant number of the desirable design characteristics and also provide improved shielding of the interlocking surfaces or components of the adjustment mechanism. In some embodiments, the present adjustment mechanisms provide improved pinch protection while also allowing a flat configuration upon folding, ease of adjustment, and relatively inexpensive and easy manufacture and/or assembly.

A preferred embodiment involves an adjustment mechanism for a chair, including a housing having a forward wall, a rearward wall and a pair of side walls extending between the forward wall and the rearward wall. The forward wall, rearward wall and side walls cooperate to define an interior space and a bottom wall substantially closes a lower end of the interior space, preferably with the exception of guide slot extends through the bottom wall in a longitudinal direction along the housing. At least a first adjustment surface and a second adjustment surface are provided, each of which extend in a lateral direction within the interior space. The first adjustment surface and the second adjustment surface are spaced from one another in the longitudinal direction. An adjustment arm, the adjustment arm extends through the guide slot and has a first portion within the interior space of the housing and a second portion outside of the interior space. The first portion of the adjustment arm defines an engagement surface configured for selective engagement with one of the first and second adjustment surfaces. The first portion further comprises a retention element that defines a retention surface, which contacts the bottom wall to limit downward movement of the adjustment arm and prevent disengagement of the adjustment arm from the housing. The second portion of the adjustment arm defines an attachment portion that is configured to be attachable to a component of the chair. The adjustment arm is movable between a first vertical position and a second vertical position relative to the housing, wherein in the first vertical position the adjustment arm is able to move in the longitudinal direction from one side of the first adjustment surface to the other side of the first adjustment surface and in the second vertical position the engagement surface of the adjustment arm is able to engage either one of the first and second adjustment surfaces to selectively adjust a longitudinal position of the engagement arm relative to the housing.

In some arrangements of the adjustment mechanism, the first adjustment surface is defined by a first adjustment pin supported relative to the housing and the second adjustment surface is defined by a second adjustment pin supported relative to the housing. A third adjustment surface, fourth adjustment surface, fifth adjustment surface or additional adjustment surfaces can be provided. Preferably, the adjustment arm is capable of passing from one side to the other side of a sufficient number of the provided adjustment surfaces to permit the adjustment arm to engage each of the provided adjustment surfaces. In some arrangements, the retention element is a retention pin that is offset from the engagement surface in a lateral direction.

Preferably, in some embodiments, a maximum width of the first portion of the adjustment arm defines a first longitudinal dimension and a distance between the first and second adjustment surfaces defines a second longitudinal dimension, wherein the first longitudinal dimension is greater than the second longitudinal dimension such that the first portion of the adjustment arm cannot move upward through a space between the first and second adjustment surfaces. In some embodiments, the first portion of the adjustment arm includes a ledge defining a guide surface that extends in a longitudinal direction from the engagement surface. The ledge is configured to contact a closest one of the first and second adjustment surfaces when the adjustment arm is moved from the first position toward the second position to guide the adjustment surface toward the engagement surface.

In some arrangements, the housing can include an access opening that extends in a lateral direction from the guide slot and passes through the bottom wall. The access opening is configured to permit the retention element to pass through the access opening. In a first angular orientation of the adjustment arm relative to the housing, the first portion of the adjustment arm is sized and shaped such that the retention element can move from the interior space into the access opening, thereby permitting removal of the first portion of the adjustment arm from the interior space through the guide slot. In a second angular orientation of the adjustment arm, one or more of the walls and the adjustment surfaces interferes with movement of the first portion of the adjustment arm such that the retention element is prevented from entering the access opening.

In some arrangements, a rearward portion of the guide slot passes through a portion of the rear wall of the housing and is configured to receive a portion of the adjustment arm such that the adjustment arm can be angled relative to the housing into a collapsed orientation. Preferably, a width of the guide slot is substantially equal to a thickness of the adjustment arm such that no substantial gap exists in a lateral direction between the adjustment arm and a surface of the bottom wall that defines the guide slot. In some embodiments, the width of the guide slot is less than about 6 millimeters.

An embodiment involves an adjustment mechanism for a chair. The adjustment mechanism can include a housing having a side wall portion defining a perimeter of an interior space of the housing, a bottom wall that substantially closes a lower end of the interior space, a guide slot that extends through the bottom wall in a longitudinal direction along the housing, and at least a first adjustment surface and a second adjustment surface, each of which extend in a lateral direction within the interior space. The first adjustment surface and the second adjustment surface are spaced from one another in the longitudinal direction. An adjustment arm extends through the guide slot and has a first portion within the interior space of the housing and a second portion outside of the interior space. The first portion of the adjustment arm defines an engagement surface configured for selective engagement with one of the first and second adjustment surfaces and the second portion of the adjustment arm defines an attachment portion that is configured to be attachable to a component of the chair. The adjustment arm is movable between a first vertical position and a second vertical position relative to the housing. In the first vertical position, the adjustment arm is able to move in the longitudinal direction from one side of the first adjustment surface to the other side of the first adjustment surface and, in the second vertical position, the engagement surface of the adjustment arm is able to engage either one of the first and second adjustment surfaces to selectively adjust a longitudinal position of the engagement arm relative to the housing. The guide slot has a maximum width dimension of less than about 6 millimeters and the adjustment arm has a thickness that is substantially equal to the maximum width dimension of the guide slot such that no substantial gap is created in a lateral direction between the adjustment arm and a surface of the housing that defines the guide slot.

In some arrangements, the first adjustment surface is defined by a first adjustment pin supported relative to the housing and the second adjustment surface is defined by a second adjustment pin supported relative to the housing. In some arrangements, the first portion of the adjustment arm defines a maximum longitudinal dimension that is sufficient to prevent the first portion of the adjustment arm from moving entirely through a space between the first and second adjustment surfaces. In some arrangements, the first portion of the adjustment arm includes a ledge defining a guide surface extending in a longitudinal direction from the engagement surface. The ledge is configured to contact a closest one of the first and second adjustment surfaces when the adjustment arm is moved from the first position toward the second position to guide the adjustment surface toward the engagement surface. A rearward portion of the guide slot can pass through a rearward portion of the side wall of the housing and receive a portion of the adjustment arm when the adjustment arm is angled relative to the housing in a collapsed orientation.

An embodiment involves an adjustable chair having a stationary portion and an adjustable portion that is adjustable relative to the stationary portion. The stationary portion includes a frame portion and the adjustable portion includes a backrest portion and an armrest portion. The chair includes an adjustment mechanism that permits adjustment of the adjustable portion into a selected one of at least two adjustment positions. The adjustment mechanism includes a housing that is coupled to one of the stationary portion and the adjustable portion. An adjustment member is coupled to the other of the stationary portion and the adjustable portion. The housing defines a guide slot through which the adjustment member can move relative to the housing between the at least two adjustment positions. The adjustment member has a first position relative to the housing in which the adjustment member can move relative to the housing and a second position relative to the housing in which the adjustment member can be locked in the selected one of the at least two adjustment positions. In the second position, respective engagement surfaces of the adjustment member and the housing contact one another to inhibit relative movement of the adjustment member and the housing to secure the adjustment member into the selected one of the at least to adjustment positions. The housing, along with the one of the stationary portion and the adjustable portion to which the housing is coupled, completely encloses the engagement surfaces of the adjustment member and the housing with the exception of the guide slot.

In some arrangements of the chair, the guide slot has a maximum width dimension of less than about 6 millimeters. In other arrangements, the guide slot can have a maximum width dimension of about 4 millimeters. The adjustment member can be movable to an angled orientation relative to the housing which permits the adjustment member to be inserted into and removed from the housing, wherein the adjustment member is restrained from moving to the angled orientation when assembled to the chair.

Embodiments also include methods of manufacturing the adjustment mechanisms and/or chairs or other objects incorporating one or more adjustment mechanisms. The manufacturing process can include positioning the adjustment element or arm in a first angular orientation relative to the housing to permit the adjustment element to be inserted through the guide slot. The adjustment element can then be coupled to a component of the chair or other object, which can restrain the adjustment element from exiting the guide slot by contacting portions of the housing, chair or other object, and/or by inhibiting or preventing rotation of the adjustment element to the first position after assembly. Methods of manufacturing can include assembling the adjustment element or arm into the housing, and then assembling one or more of the components that define the adjustment surfaces to the housing, the one or more components then inhibiting or preventing removal of the adjustment element from the housing.

### BRIEF DESCRIPTION OF THE DRAWINGS

These and other features, aspects and advantages of the present chair adjustment mechanism are described herein with reference to drawings of preferred embodiments, which are provided for the purpose of illustration and not for limitation. The drawings contain seventeen (17) figures.

FIG. 1 is a perspective view of an adjustable chair including a pair of adjustment mechanisms having certain features, aspects and advantages of the present invention.

FIG. 2 is an enlarged perspective view of a portion of the adjustable chair of FIG. 1 illustrating one of the adjustment mechanisms interconnecting an arm and a pair of legs of the chair.

FIG. 3 is a side view of a portion of the adjustable chair of FIG. 1 illustrating one of the adjustment mechanisms in a folded configuration of the chair.

FIG. 4 is a partial front view of the adjustment mechanism of FIG. 3 in the folded configuration of the chair.

FIG. 5 is a side view of an adjustment arm removed from the adjustment mechanism.

FIG. 6 is a rear view of the adjustment arm of FIG. 5.

FIG. 7 is a side view of an adjustment case of the adjustment mechanism.

FIG. 8 is a top view of the adjustment case of FIG. 7.

FIG. 9 is a bottom view of the adjustment case of FIG. 7.

FIG. 10 is a rear view of the adjustment case of FIG. 7.

FIG. 11 is a cross-sectional view of the adjustment mechanism taken along line 11-11 of FIG. 8 including the adjustment arm being introduced into the adjustment case.

FIG. 12 is a cross-section view of the adjustment mechanism similar to FIG. 11, with the adjustment arm in one of several selectable positions. The adjustment arm is shown in another selectable position in dashed lines.

FIG. 13 is a cross-sectional view of the adjustment mechanism similar to FIG. 11, with the adjustment arm in a position in which it can move between the several selectable positions.

FIG. 14 is a side view of a modification of the adjustment case of an alternative adjustment mechanism, which has a greater number of selectable positions compared to the adjustment case of FIGS. 7-10.

FIG. 15 is a top view of the adjustment case of FIG. 14.

FIG. 16 is a bottom view of the adjustment case of FIG. 14.

FIG. 17 is a rear view of the adjustment case of FIG. 14.

### DETAILED DESCRIPTION OF THE EMBODIMENTS

The adjustment mechanisms disclosed herein are well-suited for use in an adjustable chair to permit adjustment of a position of one portion of the chair relative to another portion of the chair. In the illustrated arrangements, the chair is foldable or collapsible and the adjustment mechanism permits an arm of the chair to be adjusted relative to a frame of the chair. Preferably, adjustment of the arm of the chair adjusts a recline position of a back of the chair. In addition, preferably, an adjustment mechanism is provided on each of the arms of the chair. However, the adjustment mechanism can be used to permit adjustment of other features of a chair and/or can be provided in other locations or between other portions of the chair. Moreover, the adjustment mechanism may find utility in a variety of other applications to permit adjustment of one structural element relative to another structural element.

The adjustment mechanisms are disclosed herein in the context of an adjustable or foldable chair, which can be unfolded and positioned on a surface. The chair can also be folded into a generally flat configuration. The adjustment mechanisms are often described herein using relative terms, such as forward, rearward, above, below, upper, lower, left and right. These terms are used for convenience and usually in the context of the specific figure(s) being described, unless otherwise noted or apparent from the context.

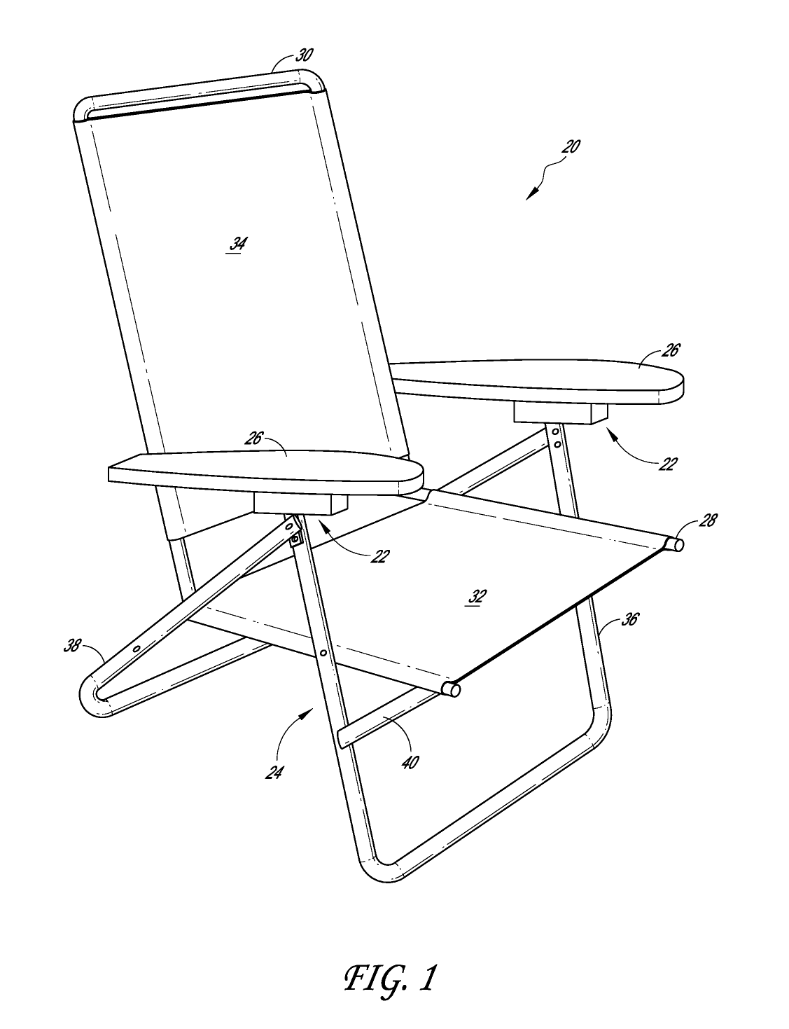

FIG. 1 illustrates a foldable, adjustable chair 20 that includes at least one adjustment mechanism 22. The illustrated chair 20 includes a pair of adjustment mechanisms 22 on each side of the chair 20. The adjustment mechanism 22 permits adjustment of one component or portion of the chair 20 relative to another component or portion of the chair 20. The illustrated chair 20 includes a frame 24 and a pair of armrests or arms 26 supported by or relative to the frame 24 and extending in a fore-aft direction on each side of the chair 20. The frame 24 can include a seat frame portion 28 and a backrest or back frame portion 30. The seat frame portion 28 can support or define a seat portion 32 of the chair 20 and the back frame portion 30 can support or define a backrest 34 of the chair 20. The seat frame portion 28, seat portion 32, back frame portion 30 and backrest 34 can be of any suitable construction. For example, each one or a combination of several of these components can be constructed of a unitary piece of material. In other arrangements, the frame portions 28, 30 can be of a rigid material (e.g., metal or plastic, rod or tubular) construction and the seat 32 and backrest 34 can be constructed of a fabric (or other suitable material) panel or plurality of panels or strips that extend between or are supported by the frame portions 28, 30.

The frame 24 preferably also includes at least one front leg portion 36 and at least one rear leg portion 38. The front leg portion 36 and rear leg portion 38 can be of any suitable construction. For example, one or both of the front leg portion 36 and rear leg portion 38 can include multiple legs. That is, the chair 20 can include two (or more) front legs and two (or more) rear legs, which may or may not be coupled to one another. However, in the illustrated arrangement, the front leg portion 36 includes a generally U-shaped frame portion, and can include one or more cross supports 40. Similarly, the illustrated rear leg portion 38 includes a generally U-shaped frame portion, and can include optional cross supports (not shown). The front leg portion 36 and rear leg portion 38 support the seat frame portion 28, seat portion 32, back frame portion 30 and backrest 34.

In addition, the front leg portion 36 and the rear leg portion 38 preferably are pivotally coupled to one another at or near their upper ends (free ends of the U-shaped frame portions). Accordingly, the front leg portion 36 and the rear leg portion 38 can fold relative to one another. Preferably, the front leg portion 36 and the rear leg portion 38 can fold one inside the other such that the frame portions are positioned side-by-side in a lateral direction, thereby minimizing the thickness of the folded leg portions 36, 38 in the folded configuration. In the illustrated arrangement, the front leg portion 36 has a smaller lateral dimension than the rear leg portion 38 so that the front leg portion 36 is positioned within the rear leg portion 38. However, this orientation could also be reversed. Furthermore, preferably the seat portion 32 and backrest 34 are pivotally connected and can fold relative to one another so that the entire chair 20 can fold in a manner well known to those in the art.

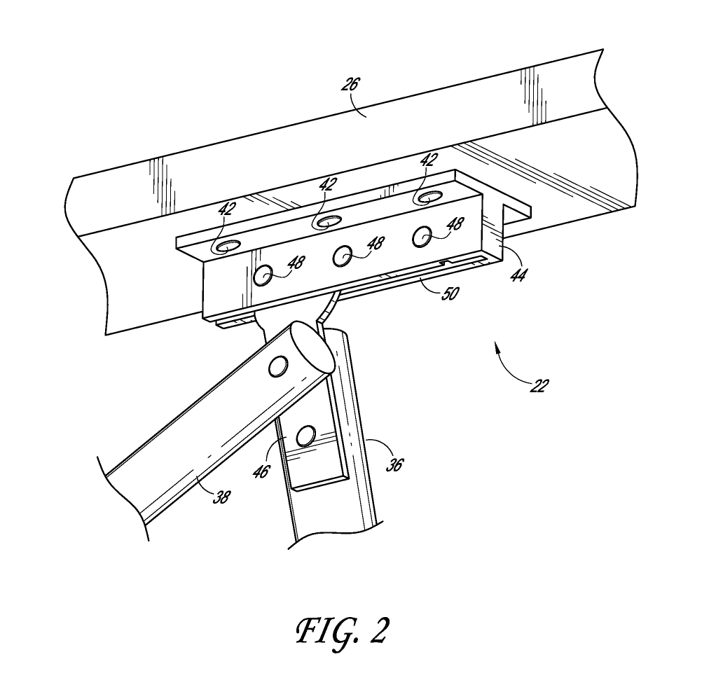

FIG. 2 illustrated one embodiment of an adjustment mechanism 22, which adjustably connects the front and rear leg portions 36, 38 to one of the arms 26. FIG. 2 illustrates the right side adjustment mechanism 22. However, the left side adjustment mechanism 22 preferably is identical to or a mirror image of the right side adjustment mechanism 22 and, thus, is not separately described herein. Preferably, the adjustment mechanism 22 is coupled to a downwardly-facing surface of the arm 26 by any suitable method or mechanism, such as by a plurality of fasteners 42. The adjustment mechanism 22 permits the arm 26 to move to any selected one of a plurality of possible adjustment positions. The illustrated adjustment mechanism 22 includes three adjustment positions; however, a lesser or greater number of adjustment positions can be provided. In addition, it is possible to have an adjustment mechanism with a single position (in an unfolded orientation of the chair 20), which is operable to permit simple movement between a folded position and a single unfolded position. In the illustrated arrangement, adjustment of the arms 26 of the chair 20 results in angular adjustment of the backrest 34. Accordingly, the illustrated adjustment mechanism(s) 22 can be referred to herein as backrest 34 reclining adjustment mechanisms.

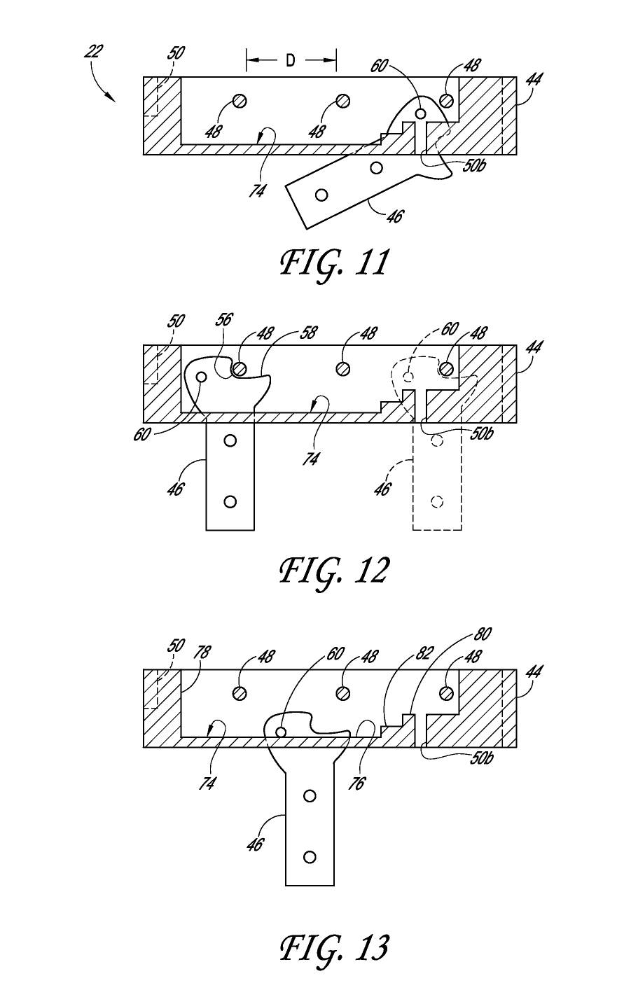

The adjustment mechanism 22 can include a housing, which is referred to herein as a tracking body or tracking case 44, and an adjustment element, which is referred to herein as a tracking or adjustment arm 46. The adjustment arm 46 is movable relative to the case 44 and can be secured in one of the adjustment positions relative to the case 44. Thus, the adjustment arm 46 operates in a manner similar to and can be referred to as a “pawl” or “follower” and the tracking case 44 operates in a manner similar to and can be referred to as a “cam”. In the illustrated mechanism 22, the adjustment positions are defined by engagement, adjustment or stop surfaces that can be engaged by the arm 46. The engagement surfaces can each be defined by a portion of an adjustment element, such as an adjustment pin 48, which can be supported by the case 44 and can be defined by any suitable structure, such as a rivet, screw, bolt, pin, etc. The engagement surfaces can also be defined by an integral or unitary portion of the case 44. The adjustment pins 48 extend in a lateral direction through the case 44. The case 44 is of an elongate, generally hollow construction. A slot 50 extends lengthwise along a bottom of the case 44 and the arm 46 passes through the slot 50 such that a portion of the arm 46 is positionable within the hollow interior of the case 44 and a portion of the arm 46 is outside of the case 44. The arm 46 can move within the slot 50 in a fore-aft direction relative to the case 44 to any desired one of the adjustment positions and be engaged with an adjustment pin 48, as described further below with reference to FIGS. 11-13.

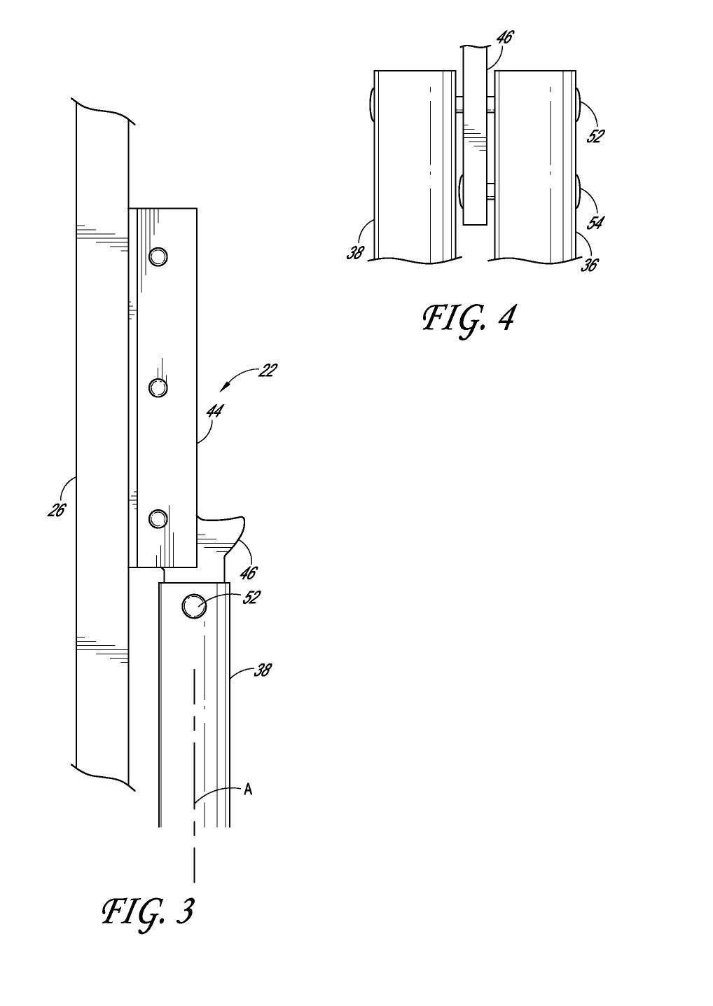

With reference to FIGS. 3 and 4, advantageously, the illustrated adjustment mechanism 22 permits folding of the chair 20 into a relatively thin configuration. Preferably, in the folded configuration, as described above, the front leg portion 36 and rear leg portion 38 are positioned side-by-side in the lateral direction. Preferably, the front leg portion 36 is positioned on one (e.g., inner or inboard) side of the adjustment arm 46 and the rear leg portion 38 is positioned on an opposite (e.g., outer or outboard) side of the arm 46. Preferably, a pivot 52 extends through the front leg portion 36, the adjustment arm 46 and the rear leg portion 38. The pivot 52 can be of any suitable construction, such as a rivet, bolt or pin. Preferably, the adjustment arm 46 is fixed for movement with one of the legs 36, 38 and is rotatable with respect to the other leg 36, 38. In the illustrated arrangement, the arm 46 is fixed to the front leg portion 36, such as by a fastener 54 (e.g., rivet, bolt or pin), which is spaced from and is a secondary fastener along with pivot 52.

As shown in FIG. 3, when the leg portions 36, 38 are in a folded configuration relative to each other and the armrest 26, an axis A of the leg(s) 36, 38 is generally parallel with an adjacent surface of the armrest 26 or with the armrest 26 in general. In the folded configuration, preferably, the adjustment arm 46 extends through a portion of the slot 50 defined in a rear surface of the tracking case 44, which facilitates the folding of the chair 20 into a relatively thin configuration. Advantageously, the nesting of the leg portions 36, 38 and general alignment of the leg portions 36, 38 and the armrest 26 allows the chair 20 to be relatively thin in the folded configuration, which allows a greater number of chairs 20 to be placed in a container or other packaging relative to other foldable chair designs thereby reducing shipping costs and the resulting cost of the chair 20 to the consumer.

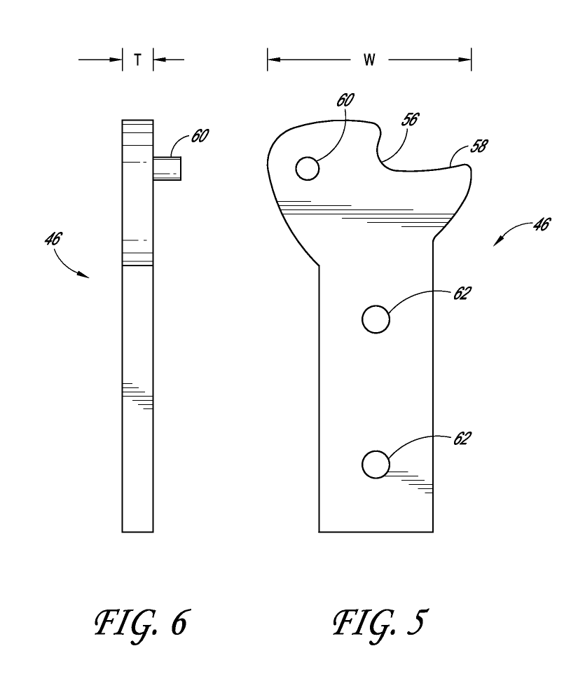

FIGS. 5 and 6 illustrate an embodiment of the adjustment arm 46 separate from the case 44. The illustrated arm 46 is a relatively thin, plate-like member, with an upper hook-like portion. The arm 46 defines a thickness T in a lateral direction (relative to the chair 20 when assembled), which preferably is slightly smaller than a width W of the slot 50 (FIG. 8). Accordingly, a gap between either side of the arm 46 and the surfaces of the case 44 defining the slot 50 is small and reduces the risk of an object, such as a person's finger, other body part, article of clothing or other item, from getting pinched between the arm 46 and the case 44. Moreover, preferably, the width W of the slot 50 is relatively small to reduce the risk of an object, such as the aforementioned objects, from entering the slot 50. Preferably, the width of the slot 50 is substantially smaller than a width of the bottom wall of the case 44. For example, the width W of the slot 50 can be between about 2 and about 10 millimeters, between about 3 and about 6 millimeters, or can be about 4 millimeters. The slot 50 can be less than about 10 millimeters, less than about 8 millimeters, less than about 6 millimeters, or equal to or less than about 4 millimeters. Preferably, the thickness T of the arm 46 can be a corresponding size that preferably minimizes a gap between the arm 46 and the case 44, while permitting free and smooth movement of the arm 46 back and forth within the slot 50.

The hook-like upper portion of the arm 46 defines an engagement surface 56 that is capable of engaging an engagement surface or portion of one of the adjustment pins 48. Preferably, the engagement surface 56 generally conforms to the shape of the engagement surfaces of the adjustment pins 48. In the illustrated arrangement, the engagement surface 56 is rounded or curved and generally corresponds to a size or diameter of the adjustment pins 48. A ledge portion 58 extends forward from the engagement surface 56. The ledge 58 can contact an adjustment pin 48 to limit upward movement of the arm 46 relative to the case 44. In addition, the upper portion of the arm 46 defines a width W that preferably is greater than a gap distance D between the adjustment pins 48 (FIG. 11) to prevent the upper portion of the arm 46 from passing between an adjacent pair of the pins 48, thereby ensuring that the ledge 58 or the engagement surface 56 contacts one of the adjustment pins 48 regardless of where the arm 46 is positioned within the length of the slot 50.

The adjustment arm 46 preferably also includes a retention element configured to retain the adjustment arm within the case 44. The illustrated retention element is a restrictor pin 60, which extends laterally outward from a side surface of the arm 46. The restrictor pin 60 cannot pass through the slot 50 and, thus, prohibits disengagement of the arm 46 and the case 44. That is, the restrictor pin 60 operates as a restriction mechanism. As described below, the hollow interior of the case 44 defines a space configured to accommodate the restrictor pin 60 during movement of the arm 46 within the slot 50. The illustrated adjustment arm 46 also includes a pair of openings 62, which pass laterally through the arm 46 and accommodate the pivot 52 and fastener 54 (FIG. 4). The openings 62 are aligned and vertically-spaced from one another.

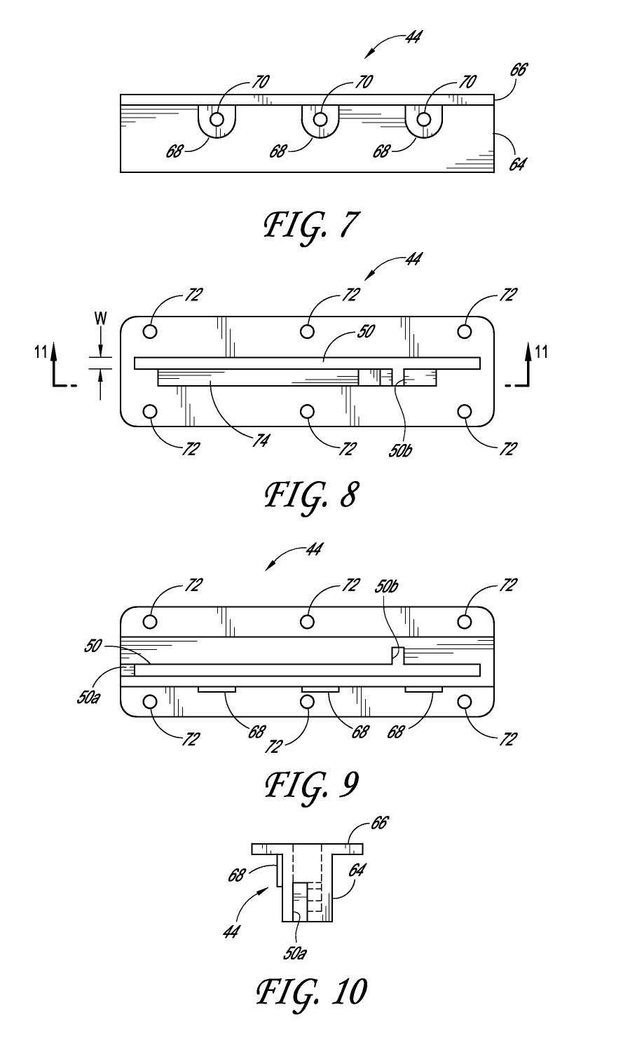

FIGS. 7-10 illustrate an embodiment of the tracking case 44. The illustrated case 44 is elongate and generally rectangular in side plan view and generally T-shaped when viewed from the front or rear. Thus, the case 44 includes a lower body portion 64 and an upper flange portion 66 that is wider in a lateral direction than the body portion 64. The case 44 can include bosses 68 in one or both side surfaces, each of which surrounds one of the openings 70 that support the adjustment pins 48. In the illustrated case 44, at least one, and preferably a plurality of openings 72 extend in a vertical direction through the flange portion 66 to accommodate the fasteners 42 that secure the adjustment mechanism 22 to the armrests 26 of the chair 20. Preferably, the openings 72 are spaced along each side of the flange portion 66. Six openings 72, three on each side, are provided in the illustrated case 44.

The slot 50 preferably extends completely through the case 44 in the vertical direction. When the case 44 is coupled to the armrest 26 of the chair 20, the lower surface of the armrest 26 closes an upper end of the slot 50 and acts as a stop surface to prevent the adjustment arm 46 from exiting an upper end of the slot 50. With reference to FIG. 10, a portion 50a of the slot 50 extends through the rear surface of the case 44. Preferably, the portion 50a extends upwardly from a lower surface of the case 44 to an intermediate location on the body portion 64 of the case 44. The portion 50a accommodates a portion of the adjustment arm 46 when the leg portions 36, 38 and/or the chair 20 are in a folded configuration (FIG. 3). The slot 50 preferably also includes a portion 50b that extends laterally from the remainder of the slot 50 and is configured to accommodate the restrictor pin 60 and permit the adjustment arm 46 to be introduced through a lower end of the slot 50 during initial assembly of the adjustment mechanism 22.

FIG. 11 is a cross-sectional view of the adjustment mechanism 22 during initial assembly of the adjustment arm 46 into the case 44. The upper hook-like portion of the arm 46 preferably is sized and shaped to permit the arm 46 to pass through the slot 50 when the arm 46 is angled relative to the case 44. In particular, a distance between the restrictor pin 60 and an upper most surface portion of the arm 46 is sized to permit the restrictor pin 50 to pass through the portion 50b of the slot and clear the forward-most pin 48 when the arm 46 is sufficiently angled relative to the case 44, as illustrated. In some arrangements, the arm 46 must be inserted into the slot 50 prior to one or both of the leg portions 36, 38 being assembled to the arm 46 because the presence of one or both legs 36, 38 would interfere with the case 44 and prevent the arm 46 from being angled sufficiently to clear the forward-most pin 48. However, in other arrangements, the arm 46 can be inserted into the slot 50 before the forward-most pin 48 is assembled to the case 44. In such an arrangement, the leg portions 36, 38 may be assembled to the arm 46 prior to insertion of the arm 46 into the slot 50 because it may not be necessary to rotate the arm 46. Moreover, depending on the geometry of the slot 50, the location of the portion 50b, the size, number and/or location of the pin(s) 48, it may be necessary or desirable to insert the arm 46 into the slot 50 prior to assembly of pin(s) 48 in addition to or other than the forward-most pin 48 to the case 44. Thus, arm 46 may be inserted into the slot 50 prior to assembly of the any or all of the rearward-most pin 48 or one or more intermediate pins 48 during initial assembly of the adjustment mechanism 22.

FIG. 12 illustrates the arm 46 in one of the possible adjustment positions relative to the case 44. A second position is illustrated with the arm 46 in dashed lines. In the illustrated arrangement, a third intermediate position is possible between the illustrated positions when the arm 46 is in engagement with the center adjustment pin 48. As described above, the engagement surface 56 of the arm 46 contacts or engages the engagement pin 48 to secure the arm 46 in a desired one of the possible adjustment positions. In the illustrated arrangement, the structure of the leg portions 36, 38 of the chair 20 maintains the front leg portion 36, or at least an upper end portion of the leg 36, in a generally consistent rotational position relative to the case 44, such as a generally vertical direction and, thus, the arm 46 in a generally consistent (e.g., vertical) rotational position when the chair 20 is on a generally horizontal surface. As described above, the width W of the upper portion of the arm 46 is sized such that it cannot pass between the pins 48 and the combination of the rounded upper edge surface of the arm 46 rearward of the engagement surface 56 and the ledge 58 ensure that the arm 46 moves into engagement with one of the pins 48 when the armrest 26 is moved downward with respect to the front leg portion 36 (and, thus, the case 44 is moved downward with respect to the arm 46). Thus, reliable positioning and adjustment of the adjustment mechanism 22 is ensured.

FIG. 13 illustrates the arm 46 in a position relative to the case 44 wherein the arm 46 can move between adjustment positions. In other words, the arm 46 is capable of passing from one side to another of at least the adjustment pins 48 other than the forward-most pin 48. The restrictor pin 60 contacts the case 44 to prevent the adjustment arm 46 from exiting the slot 50 and disengaging from the case 44. In particular, the case 44 defines a secondary cavity portion 74 that is laterally offset, adjacent and communicating with the slot 50 and is aligned with or includes the portion 50b of the slot 50. The cavity portion 74 accommodates the restrictor pin 60 throughout the movement of the arm 46 relative to the case 44, and also limits at least downward and rearward movement of the arm 46.

Preferably, the cavity portion 74 includes a lower surface 76, which contacts the restrictor pin 60 to limit downward movement of the arm 46 and prevent disengagement of the arm 46 from the case 44. The cavity portion 74 also includes a rearward surface 78 that limits rearward movement of the arm 46. Contact between the engagement surface 56 or ledge 58 can limit upward movement of the arm 46 and contact between the forward-most adjustment pin 48 and the engagement surface 56 can limit forward movement of the arm 46. The cavity portion 74 can have a raised lower surface portion 80 surrounding the portion 50b of the slot 50. The raised lower surface portion 80 contacts the restrictor pin 60 to force the arm 46 upward and into engagement with the forward-most pin 48 and prevent the restrictor pin 60 from passing through the portion 50b of the slot 50, at least when the arm 46 is generally vertical. In one arrangement, the raised lower surface portion 80 is positioned below, and preferably slightly below, the bottom of the forward-most adjustment pin 48 or other adjustment pin 48 that is closest or adjacent the portion 50b that permits the restrictor pin 60 to exit the interior of the case 44. The cavity portion 74 can include a transition surface 82 vertically between the lower surface 76 and the raised lower surface portion 80. The transition surface 82 can be a flat surface, angled surface or curved surface or any other shape to contact the restrictor pin 60 and urge the arm 46 upwardly and into contact with the forward-most adjustment pin 48.

The adjustment mechanism 22 and its various components can be constructed of any suitable, preferably rigid, material. In a preferred arrangement, the case 44 is constructed of a plastic or composite material by any suitable manufacturing method, such as injection molding. The adjustment pins 48 and adjustment arm 46 preferably are constructed of a metal material to provide strength and wear resistance. However, other suitable materials and construction methods can be employed to manufacture any of the components of the adjustment mechanism 22.

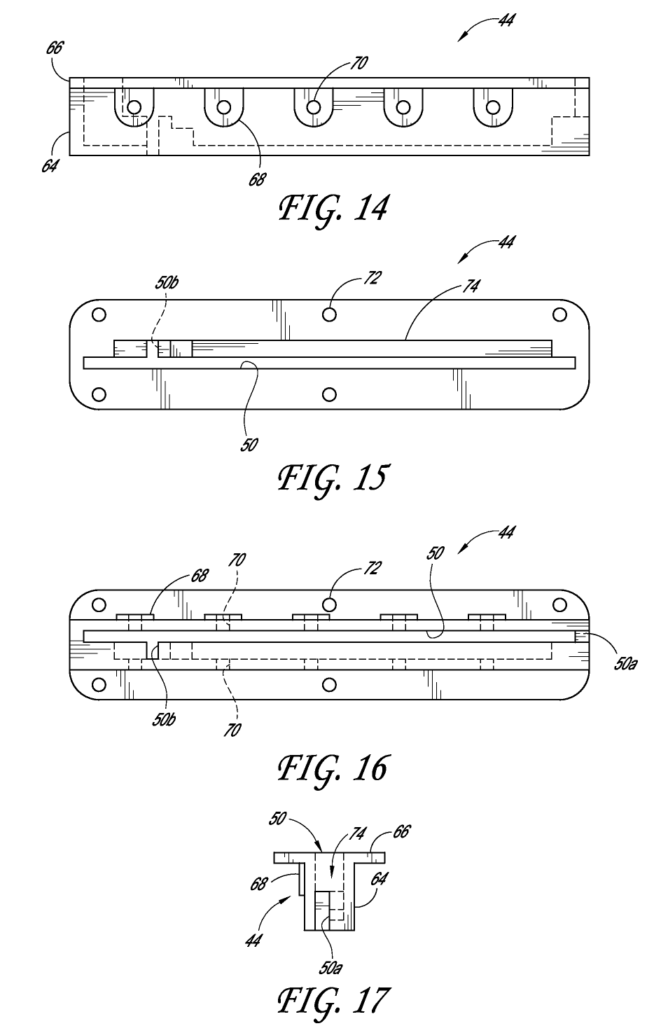

FIGS. 14-17 illustrate an embodiment of a tracking case 44 of a tracking or adjustment mechanism 22. The case 44 of FIGS. 14-17 is substantially similar in many or most respects to the case 44 of FIGS. 1-13. Accordingly, the same reference numbers or characters are used to indicate the same or similar elements. The case 44 of FIGS. 14-17 includes a greater number of openings 70 configured to support a greater number of adjustment pins 48 compared to the case 44 of FIGS. 1-13. Accordingly, an adjustment mechanism 22 constructed with the case 44 of FIGS. 14-17 provides a greater number of possible adjustment positions compared to the adjustment mechanism 22 of FIGS. 1-13. The illustrated case 44 of FIGS. 14-17 includes five adjustment positions. However, cases with four adjustment positions or six or more adjustment positions are also contemplated. The number of available adjustment positions can be selected based on the particular application for the adjustment mechanism, including whether the adjustment mechanism is intended for recline adjustment, some other adjustment of a chair or even a non-chair application. In other respects, the case 44 of FIGS. 14-17 is substantially similar or the same in construction and/or operation as the case 44 described with reference to FIGS. 1-13.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present chair adjustment mechanism has been described in the context of particularly preferred embodiments, the skilled artisan will appreciate, in view of the present disclosure, that certain advantages, features and aspects of the adjustment mechanism may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. An adjustment mechanism for a chair, comprising:
a housing having a forward wall, a rearward wall and a pair of side walls extending between the forward wall and the rearward wall, wherein the forward wall, rearward wall and side walls cooperate to define an interior space, a bottom wall that substantially closes a lower end of the interior space, a guide slot that extends through the bottom wall in a longitudinal direction along the housing;
at least a first adjustment surface and a second adjustment surface, each of which extend in a lateral direction within the interior space, the first adjustment surface and the second adjustment surface spaced from one another in the longitudinal direction; and
an adjustment arm, the adjustment arm that extends through the guide slot and has a first portion within the interior space of the housing and a second portion outside of the interior space, the first portion of the adjustment arm defines an engagement surface configured for selective engagement with one of the first and second adjustment surfaces, the first portion further comprises a retention element that defines a retention surface, the retention surface contacts the bottom wall to limit downward movement of the adjustment arm and prevent disengagement of the adjustment arm from the housing, the second portion of the adjustment arm defines an attachment portion that is configured to be attachable to a component of the chair;
wherein the adjustment arm is movable between a first vertical position and a second vertical position relative to the housing, in the first vertical position the adjustment arm is able to move in the longitudinal direction from one side of the first adjustment surface to the other side of the first adjustment surface, in the second vertical position the engagement surface of the adjustment arm is able to engage either one of the first and second adjustment surfaces to selectively adjust a longitudinal position of the engagement arm relative to the housing.

2. The adjustment mechanism of claim 1, wherein the first adjustment surface is defined by a first adjustment pin supported relative to the housing and the second adjustment surface is defined by a second adjustment pin supported relative to the housing.

3. The adjustment mechanism of claim 1, further comprising a third adjustment surface, wherein the adjustment arm is capable of passing from one side to the other side of the second adjustment surface in the first vertical position and wherein the engagement surface of the adjustment arm is capable of engaging the third adjustment surface in the second vertical position to provide a third longitudinal adjustment position of the adjustment arm relative to the housing.

4. The adjustment mechanism of claim 3, further comprising a fourth adjustment surface and a fifth adjustment surface, wherein the adjustment arm is capable of passing from one side to the other side of the third and fourth adjustment surfaces in the first vertical position and wherein the engagement surface of the adjustment arm is capable of engaging the fourth and fifth adjustment surfaces in the second vertical position to provide fourth and fifth longitudinal adjustment positions of the adjustment arm relative to the housing.

5. The adjustment mechanism of claim 1, wherein the retention element is a retention pin that is offset from the engagement surface in a lateral direction.

6. The adjustment mechanism of claim 1, wherein a maximum width of the first portion of the adjustment arm defines a first longitudinal dimension and a distance between the first and second adjustment surfaces defines a second longitudinal dimension, wherein the first longitudinal dimension is greater than the second longitudinal dimension such that the first portion of the adjustment arm cannot move upward through a space between the first and second adjustment surfaces.

7. The adjustment mechanism of claim 6, the first portion of the adjustment arm further comprising a ledge defining a guide surface extending in a longitudinal direction from the engagement surface, wherein the ledge is configured to contact a closest one of the first and second adjustment surfaces when the adjustment arm is moved from the first position toward the second position to guide the adjustment surface toward the engagement surface.

8. The adjustment mechanism of claim 1, wherein the housing further comprises an access opening that extends in a lateral direction from the guide slot and passes through the bottom wall, the access opening configured to permit the retention element to pass through the access opening, wherein in a first angular orientation of the adjustment arm relative to the housing, the first portion of the adjustment arm is sized and shape such that the retention element can move from the interior space into the access opening, thereby permitting removal of the first portion of the adjustment arm from the interior space through the guide slot, and wherein in a second angular orientation of the adjustment arm, one or more of the walls and the adjustment surfaces interferes with movement of the first portion of the adjustment arm such that the retention element is prevented from entering the access opening.

9. The adjustment mechanism of claim 1, wherein a rearward portion of the guide slot passes through a portion of the rear wall of the housing and is configured to receive a portion of the adjustment arm such that the adjustment arm can be angled relative to the housing into a collapsed orientation.

10. The adjustment mechanism of claim 1, wherein a width of the guide slot is substantially equal to a thickness of the adjustment arm such that no substantial gap exists in a lateral direction between the adjustment arm and a surface of the bottom wall that defines the guide slot.

11. The adjustment mechanism of claim 10, wherein a width of the guide slot is less than about 6 millimeters.

12. An adjustment mechanism for a chair, comprising:
a housing having a side wall portion defining a perimeter of an interior space of the housing, a bottom wall that substantially closes a lower end of the interior space, a guide slot that extends through the bottom wall in a longitudinal direction along the housing, and at least a first adjustment surface and a second adjustment surface, each of which extend in a lateral direction within the interior space, the first adjustment surface and the second adjustment surface spaced from one another in the longitudinal direction; and
an adjustment arm, the adjustment arm extends through the guide slot and has a first portion within the interior space of the housing and a second portion outside of the interior space, the first portion of the adjustment arm defines an engagement surface configured for selective engagement with one of the first and second adjustment surfaces, the second portion of the adjustment arm defines an attachment portion that is attachable to a component of the chair, wherein the adjustment arm is movable between a first vertical position and a second vertical position relative to the housing, in the first vertical position the adjustment arm is able to move in the longitudinal direction from one side of the first adjustment surface to the other side of the first adjustment surface, in the second vertical position the engagement surface of the adjustment arm is able to engage either one of the first and second adjustment surfaces to selectively adjust a longitudinal position of the engagement arm relative to the housing;
wherein the guide slot has a maximum width dimension of less than about 6 millimeters, and the adjustment arm has a thickness that is substantially equal to the maximum width dimension of the guide slot such that no substantial gap is created in a lateral direction between the adjustment arm and a surface of the housing that defines the guide slot.

13. The adjustment mechanism of claim 12, wherein the first adjustment surface is defined by a first adjustment pin supported relative to the housing and the second adjustment surface is defined by a second adjustment pin supported relative to the housing.

14. The adjustment mechanism of claim 12, wherein the first portion of the adjustment arm defines a maximum longitudinal dimension that is sufficient to prevent the first portion of the adjustment arm from moving entirely through a space between the first and second adjustment surfaces.

15. The adjustment mechanism of claim 15, the first portion of the adjustment arm further comprising a ledge defining a guide surface extending in a longitudinal direction from the engagement surface, wherein the ledge is configured to contact a closest one of the first and second adjustment surfaces when the adjustment arm is moved from the first position toward the second position to guide the adjustment surface toward the engagement surface.

16. The adjustment mechanism of claim 12, wherein a rearward portion of the guide slot passes through a rearward portion of the side wall of the housing and is configured to receive a portion of the adjustment arm when the adjustment arm is angled relative to the housing in a collapsed orientation.

17. An adjustable chair, comprising a stationary portion and an adjustable portion that is adjustable relative to the stationary portion, wherein the stationary portion comprises a frame portion and the adjustable portion comprises a backrest portion and an armrest portion, the chair further comprising an adjustment mechanism that permits adjustment of the adjustable portion into a selected one of at least two adjustment positions, the adjustment mechanism having a housing that is coupled to one of the stationary portion and the adjustable portion, and an adjustment member that is coupled to the other of the stationary portion and the adjustable portion, the housing defining a guide slot through which the adjustment member can move relative to the housing between the at least two adjustment positions, the adjustment member has a first position relative to the housing in which the adjustment member can move relative to the housing and the adjustment member having a second position relative to the housing in which the adjustment member can be locked in the selected one of the at least two adjustment positions, wherein, in the second position, respective engagement surfaces of the adjustment member and the housing contact one another to inhibit relative movement of the adjustment member and the housing to secure the adjustment member into the selected one of the at least to adjustment positions, wherein the housing, along with the one of the stationary portion and the adjustable portion to which the housing is coupled, completely encloses the engagement surfaces of the adjustment member and the housing with the exception of the guide slot.

18. The adjustable chair of claim 17, wherein the guide slot has a maximum width dimension of less than about 6 millimeters.

19. The adjustable chair of claim 17, wherein the guide slot has a maximum width dimension of about 4 millimeters.

20. The adjustable chair of claim 17, wherein the adjustment member is movable to an angled orientation relative to the housing which permits the adjustment member to be inserted into and removed from the housing, wherein the adjustment member is restrained from moving to the angled orientation when assembled to the chair.
